(19) United States
(12) Patent Application Publication
(10) Pub. No.: US 2020/0167660 A1
(43) Pub. Date: May 28, 2020

(54) AUTOMATED HEURISTIC DEEP LEARNING-BASED MODELLING

(71) Applicant: Zasti Inc., Oakton, VA (US)

(72) Inventors: Ramanathan Krishnan, Oakton, VA (US); John Domenech, Big Pine Key, FL (US); Rajagopal Jagannathan, Chennai (IN); Sharath Makki Shankaranarayana, Chennai (IN)

(21) Appl. No.: 16/590,249

(22) Filed: Oct. 1, 2019

Related U.S. Application Data
(60) Provisional application No. 62/739,773, filed on Oct. 1, 2018.

(51) Int. Cl. G06N 5/00; G06K 9/62; G06N 20/00

(52) U.S. Cl. CPC G06N 5/003; G06K 9/6296; G06K 9/6282; G06K 9/6256; G06N 20/00

(57) ABSTRACT

An automatic heuristic deporting-based modeling system is described. The system constructs a state of a space graph data structure. The data structure contains a number of nodes, each corresponding to a different machine learning model instance. Each stores a model type of the model instance, model parameter values of the model instance, and data features of the model instance. The contents of the data structure can be used to discern a model evolution history and select a model instance suited to a new machine learning project.

### CROSS-REFERENCE TO RELATED APPLICATIONS

This application claims the benefit of provisional U.S. Application No. 62/739,773, filed Oct. 1, 2018, 2018 and entitled “AUTOMATED HEURISTIC DEEP LEARNING-BASED MODELING,” which is hereby incorporated by reference in its entirety.

In cases where the present application conflicts with a document incorporated by reference, the present application controls.

### BACKGROUND

Intelligent systems built using Machine Learning typically require large teams of experts to work on solution modeling. Teams of data scientists and analysts work on structuring data, feature extraction, ML model training, etc., to arrive at the right combination of data and ML model to achieve the needed classification or prediction. Many ML algorithms require the data scientist to both select a model and specify what needs to be learned by the model. Deep Learning is a subset of Machine Learning that uses what is called representational learning, where the emphasis is on the input data provided. Deep Learning typically requires the data scientists to identify the right algorithm to apply to the data; the deep learning algorithm takes care of the learning, and the data scientist tweaks the hyperparameters of the model to improve the result. This makes Deep Learning a data-driven solution, unlike Machine Learning, which is a technique-driven solution.

### BRIEF DESCRIPTIONS OF THE DRAWINGS

FIG. 1 is a data structure diagram showing a typical state space graph used by the system in some embodiments to record its evolution of a model among multiple model instances.

FIG. 2 is a data structure diagram showing a typical search tree used by the system in some embodiments to specify efficient traversal paths within the state space graph.

FIG. 3 is a data structure diagram showing a typical feature transformation graph used by the system in some embodiments to record automatic transformations it makes among a model's features.

FIG. 4 is a flow diagram showing aspects of the main process performed by the facility in some embodiments.

FIG. 5 is a block diagram showing some of the components typically incorporated in at least some of the computer systems and other devices on which the facility operates.

### DETAILED DESCRIPTION

The inventors have analyzed how data scientists apply Deep Learning to solve a classification or regression problem, and concluded that the choice or selection of the right deep learning model tends to be more trial and error than empirical. Indeed, there is no accepted empirical method to identify the right model for the job. These studies showed that seasoned scientists were able to pick the right model more quickly than scientists who were new to the field, the difference between the two scientists being experience in working with Deep Learning. Based on these observations, the inventors have conceived and reduced to practice a software and/or hardware system that automatically selects an appropriate model for a given combination of use case and data set and employs an automated technique for selecting the right features using reinforcement learning.

To automatically select an automated model, the system applies a heuristic technique that uses a state space graph to store learnings on the accuracy of models categorized by use case and data set category.

State space refers to the set of all possible states that the problem can be in. From each state, it is usually possible to transition to some other state, given certain conditions. A state space graph is a one where every vertex represents a state, and a directed edge is drawn from one vertex to another if it possible to transition from the first vertex to the second vertex. State space search graphs are helpful for problems suited to brute force, which usually require the program to explore every possible state.

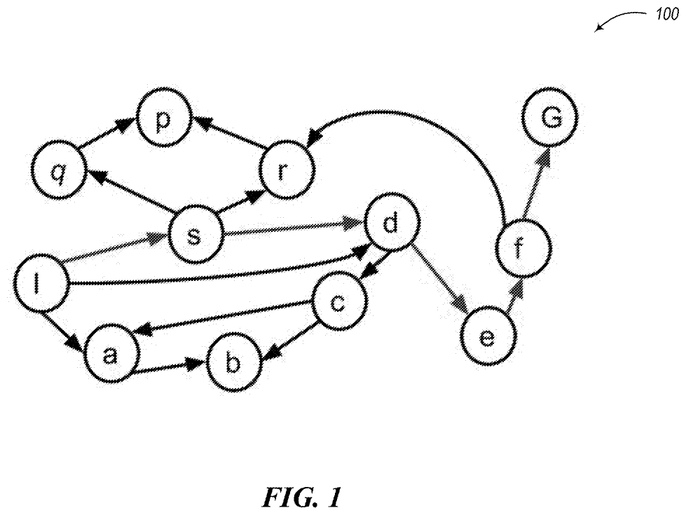

FIG. 1 is a data structure diagram showing a typical state space graph used by the system in some embodiments to record its evolution of a model among multiple model instances. In various embodiments, the system stores one or more of the following aspects of each model instance in connection with a node of the typical state space graph 100 that represents the model instance: (1) model type, also referred to as machine learning algorithm, e.g., DNN, RNN, LSTM, etc. (2) model implementation, e.g. number of layers, dropout level, etc.; (3) model hyperparameters, e.g., number of training epochs, momentum, batchsize, etc.; and (4) dataset details, e.g., data source, number of columns, column types, feature types, feature definitions, correlation with target, correlation among columns, etc. Based on validation and other testing of a graph node's model instance, the system creates a transition from that node to a new node representing a new model instance to be created, trained, and tested.

Every data set provided as input into the system is categorized by a multi-faceted library system. The library system cross-references each data set across multiple categories and use cases. Similarly, each model is cross-referenced across multiple use cases and data types. The two systems are combined to form start states, progression states, and goal states in the state space graph. Every data set provided as input into the system is categorized by a multi-faceted library system and is transformed by performing feature engineering using reinforcement learning. The library system cross-references each data set across multiple categories and use cases. Similarly, each model is cross-referenced across multiple use cases and data types. Each time a use case is presented to the system tagged along with the data set to be used, the heuristic system constructs the search tree based on these inputs, the tree is then traversed to iteratively train multiple deep learning models to arrive at the most optimum model. The published model is then validated by the data scientists, with the validation results fed back into the heuristic system as learnings.

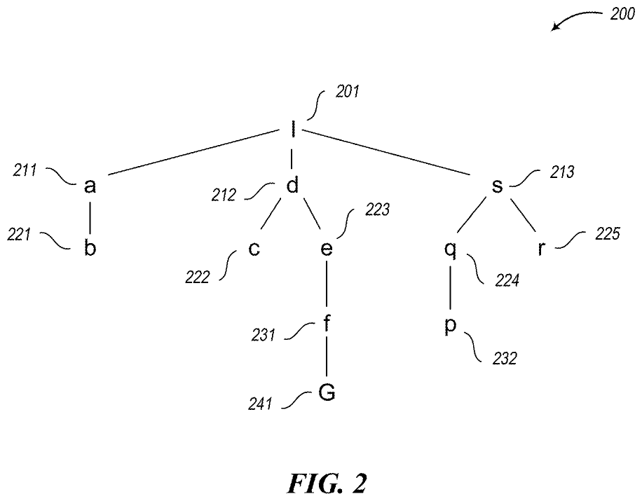

In some embodiments, to be able to quickly traverse and find the best possible path to achieve model accuracy, the system constructs a search tree. FIG. 2 is a data structure diagram showing a typical search tree used by the system in some embodiments to specify efficient traversal paths within the state space graph. In some embodiments, each node in the search tree 200 is an entire path in the state space graph. For example, node 241 in the search tree represents node G in the state space graph, as well as traversal to node G in the state spacecraft from starting state I in the state space graph. In some embodiments, to optimize resource consumption and improve efficiency, the system constructs as little of the tree as required, in a lazy, on-demand fashion.

In some cases such as predictive modeling, the system performs and organizes feature engineering to transform a given feature space, often using mathematical functions for transformation. The end goal is again to improve the predictive ability by minimizing some objective. However, there is no well-defined basis for performing effective feature engineering. It involves domain knowledge, intuition, and most of all, a lengthy process of trial and error. The human attention involved in overseeing this process significantly influences the cost of model generation. In some embodiments, the system employs a framework to automate feature engineering which is based on performance-driven exploration of a transformation graph. The system derives an exploration strategy through reinforcement learning on past examples.

Reinforcement learning, in the context of artificial intelligence, is a type of dynamic programming that trains algorithms using a system of reward and punishment and it is an approach that is inspired by behaviorist psychology. A reinforcement learning algorithm, or agent, learns by interacting with its environment. The agent receives rewards by performing correctly and penalties for performing incorrectly. The agent learns without intervention from a human by maximizing its reward and minimizing its penalty.

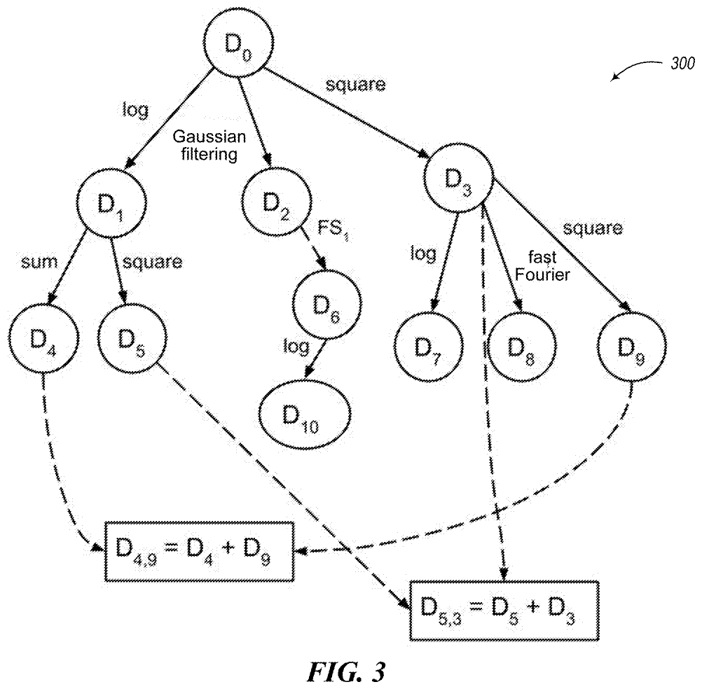

In some embodiments, system represents a feature engineering problem as a transformation graph. FIG. 3 is a data structure diagram showing a typical feature transformation graph used by the system in some embodiments to record automatic transformations it makes among a model's features. Each node of the transformation graph 300 is a candidate solution for the feature engineering problem. For example, node D₈ represents a feature where the feature of root node D₀, corresponding to a particular variable among the observations used to train the model is first squared to obtain feature D₃, then subjected to a fast Fourier transform to obtain feature D₈. Also, a complete transformation graph contains a node that is the solution to the problem, through a certain combination of transforms including feature selection. For example, the graph shows feature D_{4,9} to be a combination of features D₄ and D₉.

The massive potential size of a typical transformation graph can sometimes make its exhaustive exploration impractical. For instance, with 20 transformations and a height=5, the complete graph contains about 3.2 million nodes; an exhaustive search would include this many model training and testing iterations. On the other hand, there is no known property that allows one to deterministically verify the optimal solution in a proper subset of the trials. In some embodiments, the system uses a performance-driven exploration policy that maximizes the chances of improvement in accuracy within in a limited time budget. In some embodiments, the system uses reinforcement learning-based method called Q-learning with function approximation due to the large number of states (recall, millions of nodes in a graph with small depth) for which it is infeasible to learn state-action transitions explicitly. The graph exploration process is considered as a standard Markov Decision Process (MDP) used in reinforcement learning.

Each time a use case is presented to the system tagged along with the data set to be used, the heuristic system constructs a search tree based on these inputs. The system traverses this tree to iteratively train multiple deep learning models to arrive at the most optimum model. The published model is then validated by the data scientists, with the validation results fed back into the heuristic system as learnings.

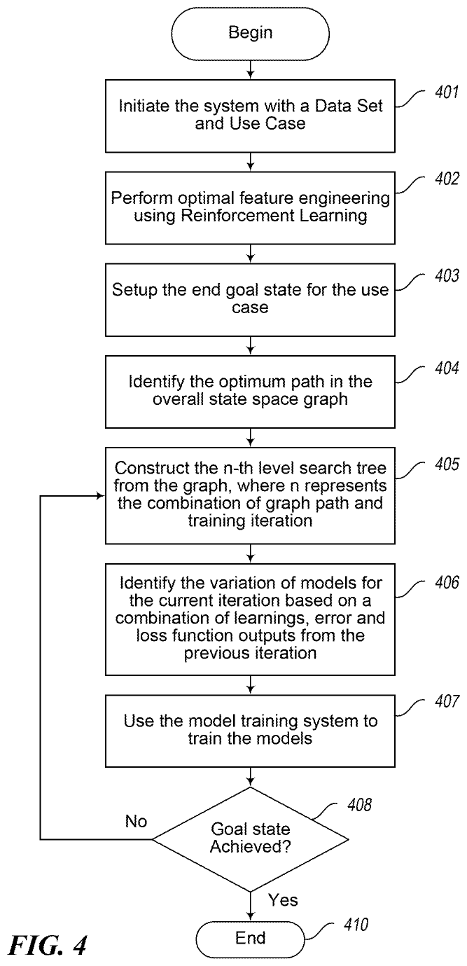

FIG. 4 is a flow diagram showing aspects of the main process performed by the facility in some embodiments. In act 401, the system is initiated with a particular data set and use case. In act 402, the system performs optimal feature engineering, such as by using reinforcement learning. In act 403, the system sets up an end goal state for the present use case. In act 404, the system identifies an optimal path to traverse through the overall state space graph. In act 405, the system constructs the nth level of the search tree from the graph, where n represents combination of graph path and training iteration. In act 406, the system identifies variation of models for the current iteration based on accommodation warnings, error, and loss function outputs from the previous iteration or iterations. In act 407, the system trains the models in accordance with the variations identified in act 406. In act 408, if the goal state is achieved by the models trained in act 407, then this process concludes, else the system continues in act 405 to construct the next level of the search tree.

One example application of the system involves a modern gas turbine engine called the Turbofan engine used by NASA. NASA has run simulations on the C-MAPSS system and created the following data set to predict the failures of Turbofan engines over time. The data set is available at PCoE Datasets.

Four different sets of engines were simulated under different combinations of operational conditions and fault modes. The data set includes time series for each engine, recording 3 operational settings and 21 sensor channels collecting different measurements related to the engine state while running, to characterize fault evolution.

Over the time series, each engine develops a fault which can be deduced from the sensor readings, but the time series ends some time prior to the failure. The data set includes Unit number, timestamps, 3 operational settings and 21 sensor readings. The data set was provided by the Prognostics CoE at NASA Ames.

This dataset has been used by many teams to predict when the next failure will occur for a given engine in the data set. Some of the most successful research teams have used the H2O platform to achieve fairly good success.

This use case and data set was programmed into the model selection system. Remaining Useful Life was setup as a calculated target field. Root Mean Squared Error (RMSE) was chosen as the indicator for model accuracy. Existing solutions for this problem have achieved a RMSE of 24.23.

The model selection system was able to quickly identify a collection of Deep Learning regression models which work the best. A Kalman Filter was applied over these models to ensemble the results. This combination when trained with the provided data set gave us a superior resulting RMSE of 23.1.

In some embodiments, the system selects models using an exhaustive search. Also, in some embodiments, the system employs Bayesian optimization techniques to perform hyperparameter or model optimization. For best model selection, in some embodiments, the system employs multiple algorithms and then performs smart ensembling to yield an improved accuracy.

In some embodiments, the system is used to select a right kind of model and the best class of algorithms. It can also be used to select the right kind of parameters given a particular model. Also, in some embodiments, the system performs automatic hyperparameter optimization.

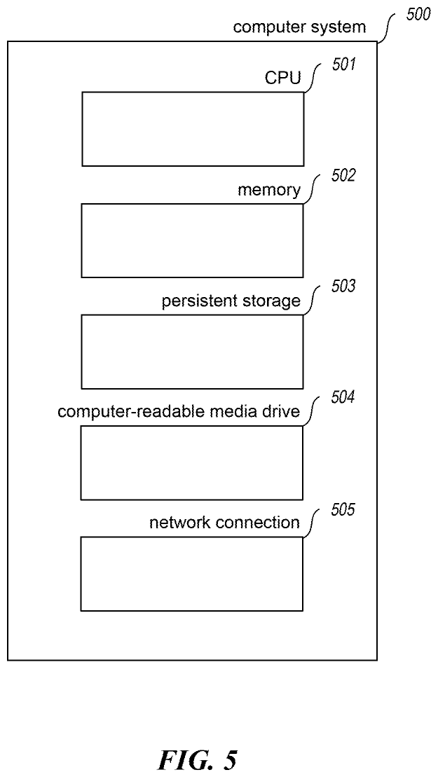

FIG. 5 is a block diagram showing some of the components typically incorporated in at least some of the computer systems and other devices on which the facility operates. In various embodiments, these computer systems and other devices 500 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 501 for executing computer programs; a computer memory 502 for storing programs and data while they are being used, including the facility and associated data, an operating system including a kernel, and device drivers; a persistent storage device 503, such as a hard drive or flash drive for persistently storing programs and data; a computer-readable media drive 504, such as a floppy, CD-ROM, or DVD drive, for reading programs and data stored on a computer-readable medium; and a network connection 505 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. A method in a computing system, comprising:
receiving input defining a problem;
based on the received input, constructing a state space graph for the problem reflecting a set of possible states that the problem can be in;
constructing at least a portion of a search tree for the constructed state space graph;
using the search tree to identify an optimum path in the state space graph;
specifying a machine learning model in accordance with the identified optimum path in the state space graph;
training the specified machine learning model; and
applying the trained machine learning model to perform at least one prediction.

2. One or more instances of computer-readable media collectively storing a machine learning automation data structure, the data structure comprising:
a plurality of state space graph nodes, each node corresponding to a different machine learning model instance, each state space graph node storing information identifying:
a model type of the model instance;
model parameter values of the model instance; and
data features of the model instance,
such that the contents of the data structure can be used to discern a model evolution history and select a model instance suited to a new machine learning project.

3. The one or more instances of computer-readable media of claim 2, the data structure further storing for each state space graph node information identifying:
a use case for the corresponding machine learning model instance.

4. The one or more instances of computer-readable media of claim 2, the data structure further storing for each state space graph node information identifying:
one or more data types for the corresponding machine learning model instance.

5. The one or more instances of computer-readable media of claim 2, the data structure further storing:
search tree nodes comprising a search tree for at least a portion of the state space graph nodes.

6. The one or more instances of computer-readable media of claim 2, the data structure further storing:
a feature transformation graph comprising feature transformation graph nodes each corresponding to a state of one or more independent variables and directed transformation graph edges each connecting a pair of transformation graph nodes and source representing a transformation function to be applied to the state of the one or more independent variables of the source transmission graph node of the pair to obtain the state of the one or more independent variables of the destination transmission graph node of the pair.

7. One or more instances of computer-readable media collectively having contents configured to cause a computing system to perform a method, the method comprising:
initializing a state space graph;
for each of a plurality of iterations:
selecting a machine learning model;
selecting parameter values for the selected machine learning model;
establishing an instance of the selected machine learning model with the selected parameter values;
accessing observations;
selecting data features represented among the observations;
allocating a plurality of the observations to training;
allocating a plurality of the observations to validation;
training the established model instance using the selected data features for the observations allocated to training;
validating the trained model instance using the observations allocated to validation; and
adding a node to the state space graph representing the selected machine learning model, parameter values, and data features.

8. The one or more instances of computer-readable media of claim 7, the method further comprising:
receiving input specifying an ending state;
for each node added to the state space graph, determining whether the model instance to which the node corresponds satisfies the specified ending state; and
where the model instance to which the node corresponds is determined to satisfy the specified ending state, terminating the plurality of iterations.

9. The one or more instances of computer-readable media of claim 7, the method further comprising:
storing in at least a portion of the added nodes a use case indication for the corresponding model instance;
receiving input specifying a use case indication for new project; and
identifying a node of the state space graph having a similar use case indication.

10. The one or more instances of computer-readable media of claim 7, the method further comprising:
storing in at least a portion of the added nodes a use case indication for the corresponding model instance;
receiving input specifying a use case indication for a new project; and
identifying a node of the state space graph having a matching use case indication.

11. The one or more instances of computer-readable media of claim 9, the method further comprising:
adapting the model instance of the identified node to the new project; and
training the adapted model instance for the new project.

12. The one or more instances of computer-readable media of claim 7, the method further comprising:
storing in at least a portion of the added nodes a use case indication for the corresponding model instance;
storing in at least a portion of the added nodes one or more observation data types for the corresponding model instance;
receiving input specifying a use case indication for a new project and one or more observation data types for the new project; and
identifying a node of the state space graph whose use case indication and data types match those of the new project.

13. The one or more instances of computer-readable media of claim 12, the method further comprising:
adapting the model instance of the identified node to the new project; and
training the adapted model instance for the new project.

14. The one or more instances of computer-readable media of claim 7, the method further comprising:
constructing a search tree for at least a portion of the state space graph; and
using the constructed search tree to traverse the state space graph.

15. The one or more instances of computer-readable media of claim 7, the method further comprising:
initializing a feature transformation graph;
adding to the feature transformation graph a root node representing a combination of one or more independent variables each in an original state;
for each of a plurality of iterations:
selecting a node in the feature transformation graph;
identifying a transformation type to apply to the combination of one or more independent variables in a state corresponding to the selected node;
adding to the future transformation graph a new non-root node, connected to the selected node by an edge labeled by the identified transformation type.

16. The one or more instances of computer-readable media of claim 15, the method further comprising:
for the combination of independent variables represented by the root node of the feature transformation graph, receiving an identification of a non-root node of the feature transformation graph;
determining a sequence of transformations encountered in traversing from the root node of the feature transformation graph to the identified non-root node of the feature transformation graph; and
performing the determined sequence of transformations to values of the combination of independent variables represented by the root node of the feature transformation graph in their original state to obtain transformed independent variable values.

17. The one or more instances of computer-readable media of claim 16, the method further comprising:
using the obtained transformed independent variable values to train one of the model instances.

18. The one or more instances of computer-readable media of claim 16, the method further comprising:
storing the obtained transformed independent variable values in one of the nodes added to the state space graph.
